(19) United States
(12) Patent Application Publication
(10) Pub. No.: US 2009/0014469 A1
(43) Pub. Date: Jan. 15, 2009

(54) CONTROLLED LIQUID SUPPLY SYSTEM

(76) Inventor: Aaron Noel Bawcom, Atlanta, GA (US)

Correspondence Address: MICHAEL A. O'NEIL, P.C., 5949 SHERRY LANE, SUITE 820, DALLAS, TX, 75225, US

(21) Appl. No.: 12/143,534

(22) Filed: Jun. 20, 2008

Related U.S. Application Data
(60) Provisional application No. 60/948,064, filed on Jul. 5, 2007.

(51) Int. Cl. B67D 5/16

(52) U.S. Cl. 222/71

(57) ABSTRACT

A system for delivering liquids at a designated temperature and a designated flow rate comprises an interface, a control unit, and at least two supply lines comprising controlled valves, servo actuators, temperature sensors, and flow rate sensors; the two supply lines feeding into a receiving line having a dual outlet valve, a servo actuator, a temperature sensor for measuring the temperature of liquid flowing through the dual outlet valve, and a flow rate sensor for measuring the rate of flow through the dual outlet valve. The control unit sends signals to the valve actuators to regulate the flow of liquid through the valves in order to achieve the designated temperature and the designated flow rate at a primary outlet.

### CROSS-REFERENCE TO RELATED APPLICATION

Applicant claims priority based on U.S. Provisional Patent Application No. 60/948,064 filed Jul. 5, 2007, the entire content of which is incorporated herein by reference.

### DESCRIPTION OF THE DRAWINGS

FIG. 1 is a schematic illustration representing a controlled liquid supply system comprising an embodiment of the present invention; and

FIG. 2 is a flowchart illustrating a method comprising an embodiment of the present invention.

### DETAILED DESCRIPTION

Various household and industrial activities can benefit from the delivery of liquids at a designated temperature and a designated flow rate. Heretofore systems have been available for controlling the temperature of liquids flowing through an outlet such as a faucet or a shower head; however, none has provided constant monitoring and correction of both the temperature and the flow rate of a liquid.

In accordance with an embodiment of the present invention a liquid supply system comprises a user interface for setting a designated temperature and a designated flow rate and a system of actuator controlled valves for delivering the liquid to a specified outlet at the designated temperature and designated flow rate. The user interface receives input from a user and comprises a control unit for communicating received inputs to components of the system, calculating needed temperature and flow rates from multiple supply lines, and receiving feedback from monitoring and control devices throughout the system. The system of controlled valves comprises at least two supply lines, each supply line comprising a valve, a servo actuator for controlling the valve, a temperature sensor for measuring the temperature of liquids flowing through the valve, and a flow rate sensor for measuring the rate of flow of liquids flowing through the valve. The supply lines extend to a receiving line comprising a dual outlet valve, a servo actuator for controlling the valve, a temperature sensor for measuring the temperature of liquids flowing through the dual outlet valve, and a flow rate sensor for measuring the rate of flow of liquids flowing through the dual outlet valve. Beyond the dual outlet valve a primary outlet discharges the liquid at the designated temperature and the designated flow rate.

A user enters a desired temperature and desired flow rate into the user interface. The user interface relays the specified temperature and specified flow rate to a control unit which, based on initial temperature and flow rate measurements from the supply lines, determines whether the desired temperature and flow rate can be achieved and if so the necessary flow rates through each of the valves. Once liquid flows through the supply lines and into the dual outlet valve the temperature and the flow rate of the liquid flowing through the valve are directed to the control unit. If the temperature and flow rate are equal to the designated temperature and the designated flow rate the dual outlet valve directs the liquid to the primary outlet. If either the temperature or the flow rate does not correspond to either the designated temperature or the designated flow rate the control unit recalculates the needed flow rates and instructs the servo actuators to adjust the valves accordingly. The flow rates through the valves are continuously adjusted and monitored to assure continuity of the designated temperature and the designated flow rate.

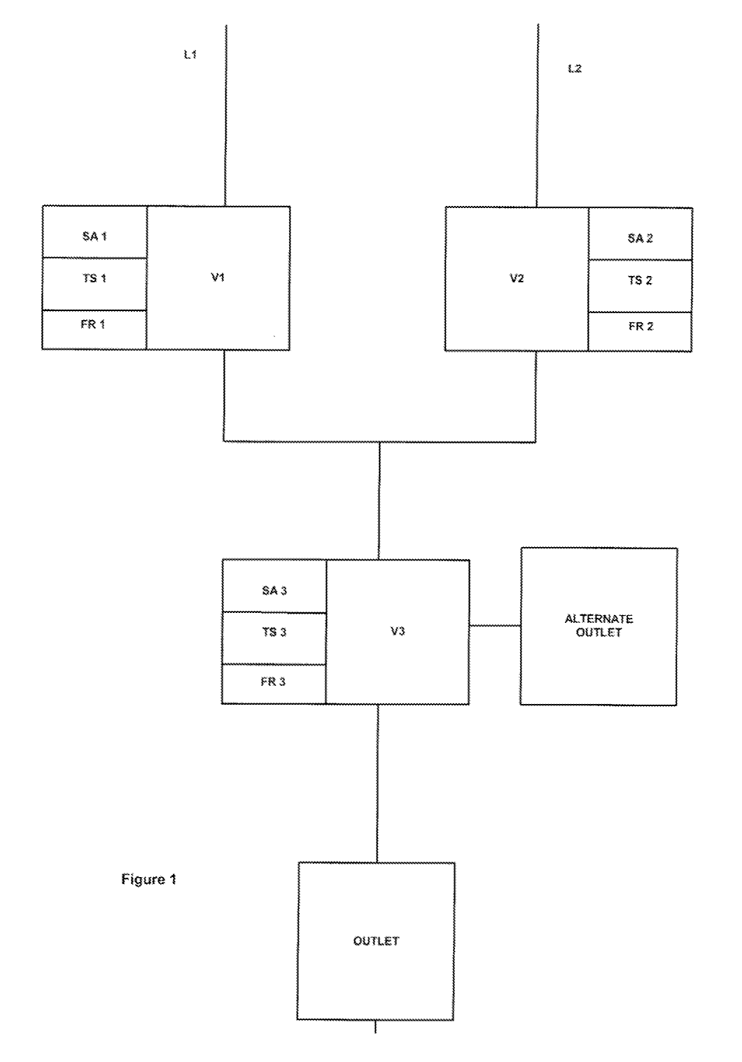

FIG. 1 illustrates a supply system for delivering liquid at a designated temperature and designated flow rate to a primary outlet. The supply system comprises a user interface for receiving inputs from a user and communicating the received inputs to a control unit coupled to the user interface. A first supply line L1 comprises a first valve V1 controlled by a first servo actuator SA1 and having a first temperature sensor TS1 for measuring the temperature T₁ of the liquid flowing through the valve V1 and a first flow rate sensor FR1 for measuring the flow rate of the liquid through the valve V1. A second supply fine L2 similarly comprises a second valve V2 controlled by a second servo actuator SA2, a second temperature sensor TS2 for measuring the temperature T₂ of the liquid flowing through the valve V2, and a second flow rate sensor FR2 for measuring the flow rate through the valve V2.

The control unit continuously communicates with the temperature sensors TS1 and TS2, the flow rate sensors FR1 and FR2, and the servo actuators SA1 and SA2 in order to maintain a current measurement of the temperatures and the flow rates of liquids flowing through each valve. Once a user has designated the desired temperature T_{d} and flow rate F_{d} to be received at the primary outlet the control unit calculates the needed flow rate for each line L1 and L2 according to the temperatures T₁ and T₂ in order to achieve the designated temperature T_{d}. If at the time the designated temperature T_{d} and/or the designated flow rate F_{d} are entered the control unit determines that the designated temperature T_{d} and/or the designated flow rate F_{d} cannot be achieved the control unit sends a signal to the user interface informing the user that the desired temperature T_{d} and/or flow rate F_{d} cannot be achieved and requests further input.

The first supply line L1 and the second supply line L2 extend to a receiving line RL having a temperature sensor TS3 for measuring the temperature T₃ of the liquid flowing through a dual outlet valve V3 controlled by a third servo actuator SA3 and a flow rate sensor FR3 for measuring the rate at which liquid is flowing through valve V3. As the liquids are received from the first and second supply lines L1 and L2 and blended within the receiving line RL the temperature T₃ and flow rate F₃ of the combined liquid are measured and communicated back to the control unit. If both the temperature T₃ and flow rate F₃ equal the designated temperature T_{d} and the designated flow rate F_{d} the liquid is directed from the dual outlet valve V3 and through the primary outlet.

If either the temperature T₃ or flow rate F₃ does not equal either the designated temperature T_{d} or the designated flow rate F_{d} the control unit sends a signal to the third actuator SA3 to direct the liquid through the dual outlet valve V3 to an alternate outlet where the liquid may either be discarded through a drain or re-directed through one or both of the first or second supply lines. The control unit recalculates the needed flow rates through the fast and second valves V1 and V2 based on the combined temperature T₃, the combined flow rate F₃, and the current temperatures T₁ and T₂ of both the first and second supply lines L1 and L2 and sends a signal to the first and second actuators SA1 and SA2 to adjust the flow rates accordingly. The above described process for correcting the combined temperature T₃ and flow rate F₃ is repeated until the combined temperature T₃ equals the designated temperature T_{d} and the combined flow rate F₃ equals the designated flow rate F_{d}.

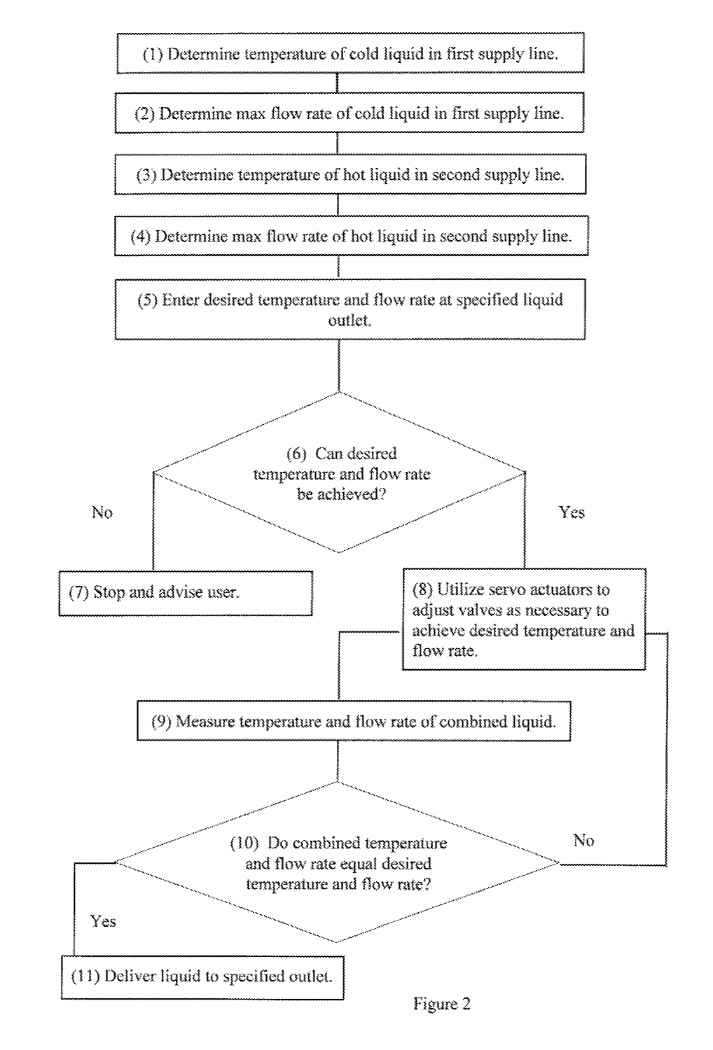

FIG. 2 comprises a flow chart illustrating a method for providing liquids to a designated outlet at a designated temperature and designated flow rate. The following steps represent the initial steps taken by a system for delivering liquids at a designated temperature and a designated flow rate: (1) determine the temperature of a cold liquid provided by a first supply line; (2) determine the maximum flow rate through the first supply line; (3) determine the temperature of a hot liquid provided by a second supply line; (4) determine the maximum flow rate through the second supply line; (5) entering the designated temperature and the designated flow rate into a user interface; (6) a control unit operating in conjunction with the user interface determines whether the designated temperature and the designated flow rate can be achieved given the data from steps (1) through (4); (7) if the designated temperature and/or the designated flow rate cannot be achieved the user is notified and the process stops unless the user provides different instructions; (8) if the designated temperature and the designated flow rate can be achieved the servo actuators in the first and second supply lines open the valves as necessary to achieve the designated temperature and the designated flow rate; (9) the liquids from the first and second supply lines are combined in a receiving line and the temperature and the flow rate of the combined liquid are measured; (10) if the temperature and the flow rate in the receiving line equal the designated temperature and the designated flow rate, then (11) the combined liquid is delivered to the primary outlet. If either the combined temperature or the combined flow rate does not equal the designated temperature or the designated flow rate, steps (8) through (10) are repeated until the designated temperature and the designated flow rate are achieved and delivered to the primary outlet.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A system for delivering liquids at a designated temperature and a designated flow rate comprising:
a user interface for receiving designated temperature and designated flow rate inputs;
a control unit for receiving the designated inputs from the interface and for controlling the operation of the system in response thereto;
a first supply line comprising a first valve, a first valve actuator for operating the first valve, a first temperature sensor for measuring the temperature of liquid flowing through the first valve, and a first flow rate sensor for measuring the rate of flow through the first valve;
a second supply line comprising a second valve, second valve actuator for operating the second valve, a second temperature sensor for measuring the temperature of liquid flowing through the second valve, and a second flow rate sensor for measuring the rate of flow through the second valve;
a receiving Hue for receiving liquids from the first supply line and the second supply line and comprising a dual outlet valve, a third valve actuator for operating the dual outlet valve, a third temperature sensor for measuring the temperature of liquids flowing through the dual outlet valve and a third flow rate sensor for measuring the rate of flow through the dual outlet valve;
a primary outlet for receiving liquids at the designated temperature and the designated flow rate from the receiving line;
an alternate outlet for receiving liquids from the receiving line that are not at the designated temperature and/or the designated flow rate;
means for measuring the temperature of liquids flowing through the first supply line;
means for measuring the rate of flow of liquids flowing through the first supply line;
means for measuring the temperature of liquids flowing through the second supply line;
means for measuring the rate of flow of liquids flowing through the second supply line;
means for measuring the rate of flow of liquid through the receiving line;
means for measuring the temperature of liquid flowing through the receiving line;
the control unit comprising means for calculating the required flow rates through each of the first and second supply lines needed to achieve the designated temperature and the designated flow rate at the primary outlet;
the first valve and the second valve comprising means for regulating the flow of liquids through the first and second supply lines according to the calculated rates;
the dual outlet valve further comprising means for diverting the liquid flowing through the receiving line to the alternate outlet when either the measured temperature does not equal the designated temperature or the measured flow rate does not equal the designated flow rate;
the dual outlet valve further comprising means for delivering the liquid at the designated temperature and the designated flow rate to the primary outlet.

2. A method for delivering liquids at a designated temperature and a designated flow rate comprising the steps of:
a. providing an interface/control unit for receiving and communicating a designated temperature and a designated flow rate;
b. entering a designated temperature and a designated flow rate into the user interface/control unit;
c. providing a first supply line comprising a first flow rate controlling valve;
d. providing means for measuring the temperature of liquids flowing through the first supply line;
e. providing means for measuring the rate of flow of liquids flowing through the first supply line;
f. providing a second supply line comprising a second flow rate controlling valve;
g. providing means for measuring the temperature of liquids flowing through the second supply line;
h. providing means for measuring the rate of flow of liquids flowing through the second supply line;
i. providing a receiving line for simultaneously receiving liquids from both the first supply line and the second supply line;
j. providing a flow directing valve in the receiving line;
k. monitoring the rate of flow of liquid through the flow directing valve in the receiving line:
l. measuring the temperature of liquid flowing through the flow directing valve of the receiving line;
m. providing a primary outlet for receiving liquid at the designated temperature and designated flow rate;
n. providing an alternate outlet:
o. calculating the required flow rates through each of the first and second supply lines needed to achieve the designated temperature and the designated flow rate at the primary outlet:
p. regulating the flow of liquids through the first and second supply lines according to the calculated rates;
q. providing an alternative outlet;
r. diverting the liquid flowing through the receiving line to the alternate outlet when either the measured temperature does not equal the designated temperature or the measured flow rate does not equal the designated flow rate;
s. repeating steps j. through m. until the measured temperature and flow rate equal the designated temperature and the designated flow rate; and
t. delivering the liquid at the designated temperature and the designated flow rate to the primary outlet.
